(19) United States
(12) Patent Application Publication
(10) Pub. No.: US 2026/0140634 A1
(43) Pub. Date: May 21, 2026

(54) STORAGE NODE, STORAGE CLUSTER AND METHOD FOR ACHIEVING DATA ACCESS ACCELERATION THEREOF

(71) Applicant: QNAP Systems, Inc., New Taipei City (TW)

(72) Inventors: Hsiu-Hsien Lee, New Taipei City (TW); Fa-Hsuan Hsiao, New Taipei City (TW); Yi-Cian Pu, New Taipei City (TW)

(21) Appl. No.: 19/372,422

(22) Filed: Oct. 29, 2025

(30) Foreign Application Priority Data
Nov. 20, 2024 (TW) 113144734

(51) Int. Cl. G06F 3/06

(52) U.S. Cl. CPC G06F 3/0613; G06F 3/0619; G06F 3/0647; G06F 3/067

(57) ABSTRACT

A storage node, a storage cluster and a method for achieving accelerating data access thereof are provided. The storage cluster includes a plurality of storage nodes. The method is performed by a processor of each of the storage nodes in the storage cluster. Each of the storage nodes includes the processor and a plurality of storage devices. The storage devices have at least two different input/output operations per second (IOPS) speeds. The method evaluates each storage device according to the IOPS speed thereof to perform an optimized sorting of the storage devices, and then migrates metadata previously stored in non-optimized storage devices to optimized storage devices so as to accelerate data access. The method further migrates the metadata stored in an optimized storage device when the IOPS speed of the optimized storage device has dropped to a threshold value.

### CROSS-REFERENCE TO RELATED APPLICATION

This application claims the benefit of priority to Taiwanese Patent Application No. 113144734 filed on November 20, 2024, the entire contents of which are incorporated herein by reference.

### BACKGROUND

### 1. Technical Field

The present disclosure relates to metadata storage technology. The present disclosure further relates to a storage node, a storage cluster and a method for achieving data access acceleration thereof.

### 2. Description of Related Art

A storage cluster (e.g., Ceph) with a plurality of storage nodes can replicate and store data objects in multiple storage nodes to provide parallel and distributed data access services, which not only improves data access efficiency, but also avoids the risk of a single point of failure.

Each storage node in a storage cluster may include a plurality of hard disk drives (HDDs) for storing data objects and their metadata, wherein the metadata includes the attributes of the data objects and the specific storage locations of the data objects in the HDDs. Therefore, before accessing a data object in an HDD of a storage node, the metadata of the data object must be read in order to know the specific storage location of the data object in the HDD for read/write operations.

At present, storage nodes usually use traditional HDDs to store data objects. The locations of data objects and their metadata in the HDDs are usually not continuous. Therefore, when a data object needs to be read, the read-and-write head of a traditional HDD needs to move to the location of the metadata first to find out the location of the data object, and then move to the location of the data object to complete the read operation. The time required for moving the read-and-write head creates a bottleneck, which drastically slows down the speed of data reading.

In addition, the metadata of data objects in the current storage nodes do not have backups, so when the metadata are accidentally damaged, the corresponding data objects cannot be accessed, which means that the data objects are also damaged, and the impact is significant.

### SUMMARY

For solving the above-mentioned problems, the present disclosure provides a storage node (also known as a data storage device), a storage cluster, and a method for achieving data access acceleration thereof, wherein the storage cluster includes a plurality of storage nodes, to improve read/write performance and storage security of data objects.

A method for achieving data access acceleration of a storage cluster of the present disclosure is performed by a storage node in the storage cluster, wherein the storage node comprises a plurality of storage devices having at least two different input/output operations per second (IOPS) speeds. The method comprises: evaluating the IOPS speed of each of the plurality of storage devices to perform an optimized sorting of the plurality of storage devices; migrating metadata originally stored in a non-optimized storage device in the optimized sorting of the plurality of storage devices to an optimized storage device in the optimized sorting of the plurality of storage devices; setting up a detection mechanism required periodically or in response to an unexpected event according to the optimized sorting; and in the detection mechanism, if the IOPS speed of the optimized storage device has dropped to a threshold value, migrating the metadata stored in the optimized storage device back to the non-optimized storage device or to another storage device of the plurality of storage devices according to a system resource of the storage node.

The method further comprises: conducting a comprehensive evaluation based on the IOPS speed and stability of each of the plurality of storage devices to perform the optimized sorting of the plurality of storage devices.

In an embodiment, the stability of each of the plurality of storage devices is generated according to a historical record of each of the plurality of storage devices and/or a historical record of a different storage device of a same type as that of each of the plurality of storage devices. The stability of each of the plurality of storage devices is a life expectancy of each of the plurality of storage devices or a temperature range of an environment of each of the plurality of storage devices.

In an embodiment, the IOPS speed and/or the stability of the optimized storage device is higher than the IOPS speed and/or the stability of the non-optimized storage device.

The method further comprises: in the detection mechanism, if the IOPS speed or the stability of the optimized storage device has dropped to a corresponding threshold value, migrating the metadata stored in the optimized storage device back to the non-optimized storage device or to the another storage device according to the system resource.

In an embodiment, the stability of the another storage device is higher than the stability of the optimized storage device, and wherein the system resource is a storage space in the another storage device allocated to the metadata.

In an embodiment, the storage space in the another storage device allocated to the metadata is larger than a storage space in the optimized storage device allocated to the metadata, and wherein the system resource is the storage space in the optimized storage device allocated to the metadata.

In an embodiment, the unexpected event comprises a newly installed storage device joining the plurality of storage devices, or one of the plurality of storage devices being removed, or malfunction of one of the plurality of storage devices.

In an embodiment, the optimized storage device is a storage array comprising a plurality of storage units, and wherein each of the plurality of storage units stores a copy of the metadata.

The method further comprises: in the detection mechanism, if at least one of the plurality of storage units of the optimized storage device has been removed or has malfunctioned, migrating the metadata stored in the optimized storage device back to the non-optimized storage device or to the another storage device according to the system resource.

A storage node of the present disclosure comprises: a plurality of storage devices having at least two different input/output operations per second (IOPS) speeds; and at least one processor configured for: evaluating the IOPS speed of each of the plurality of storage devices to perform an optimized sorting of the plurality of storage devices; migrating metadata originally stored in a non-optimized storage device in the optimized sorting to an optimized storage device in the optimized sorting; setting up a detection mechanism required periodically or in response to an unexpected event according to the optimized sorting; and in the detection mechanism, if the IOPS speed of the optimized storage device has dropped to a threshold value, migrating the metadata stored in the optimized storage device back to the non-optimized storage device or to another storage device of the plurality of storage devices according to a system resource of the storage node.

A storage cluster of the present disclosure comprises a plurality of storage nodes, wherein each of the plurality of storage nodes comprises at least one processor and a plurality of storage devices having at least two different input/output operations per second (IOPS) speeds, and wherein in each of the plurality of storage nodes, the at least one processor is configured for: evaluating the IOPS speed of each of the plurality of storage devices to perform an optimized sorting of the plurality of storage devices; migrating metadata originally stored in a non-optimized storage device in the optimized sorting to an optimized storage device in the optimized sorting; setting up a detection mechanism required periodically or in response to an unexpected event according to the optimized sorting; and in the detection mechanism, if the IOPS speed of the optimized storage device has dropped to a threshold value, migrating the metadata stored in the optimized storage device back to the non-optimized storage device or to another storage device of the plurality of storage devices according to a system resource of the storage node.

The technical solution of the present disclosure focuses on migrating the metadata of data objects from non-optimized storage devices to optimized storage devices with higher IOPS speeds and/or longer life expectancies, and, after the aforementioned migration, determining whether the metadata needs to be moved out of the optimized storage devices according to the statuses of the optimized storage devices, so as to improve the read/write performance and the storage security of the data objects. Thereby, the present disclosure can form a storage system with more efficiency or more data security after the automatic migration of the metadata.

In addition, the technical solution of the present disclosure migrates the metadata of data objects to optimized storage devices with faster access speeds, such as solid state drives (SSDs), so as to avoid the problem of the read-and-write head taking time to change its location due to discontinuous locations of the metadata in the storage device, which affects the data read speed, so as to significantly increase the read/write speed.

### BRIEF DESCRIPTION OF THE DRAWINGS

The present disclosure can be more fully understood by reading the following descriptions of the embodiments, with reference made to the accompanying drawings.

FIG. 1 is a schematic block diagram of a storage cluster of an embodiment of the present disclosure.

FIG. 2 is a flowchart of a method for achieving data access acceleration of a storage cluster of an embodiment of the present disclosure.

FIG. 3 shows test results of read/write speeds of data objects in an embodiment.

### DETAILED DESCRIPTION

The following embodiments are used for illustrating the present disclosure. A person skilled in the art can easily conceive the other advantages and effects of the present disclosure, based on the disclosure of the specification. The present disclosure can also be implemented or applied as described in different embodiments. It is possible to modify or alter the following embodiments for carrying out this disclosure without contravening its spirit and scope, for different aspects and applications.

It is further noted that, as used in this disclosure, the singular forms “a,” “an,” and “the” include plural referents unless expressly and unequivocally limited to one referent. The phrase “and/or” indicates that a plurality of features, elements or components are to be taken individually or some of the features, the elements or the components are to be taken together.

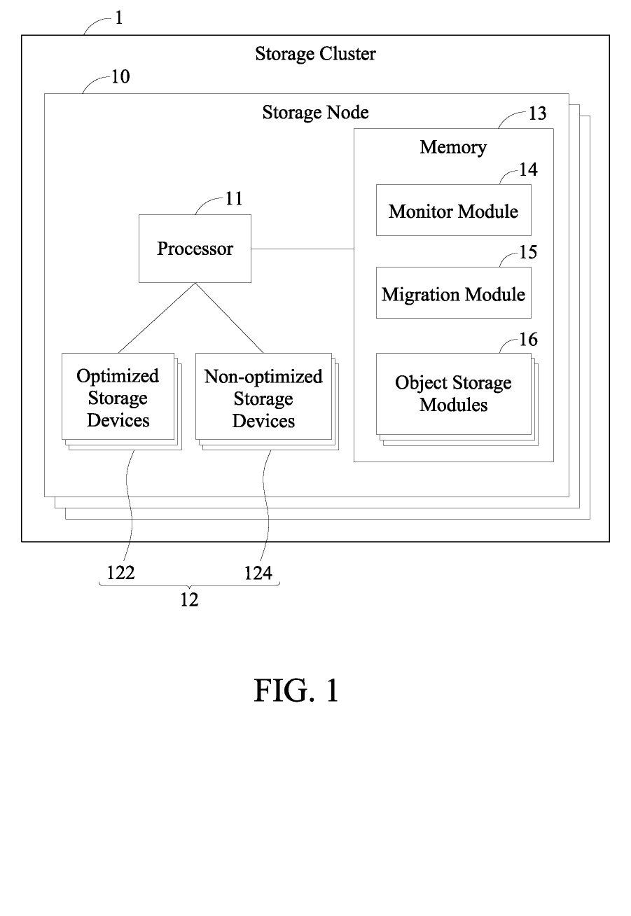

FIG. 1 is a schematic block diagram of a storage cluster 1 of an embodiment of the present disclosure. In an embodiment, the storage cluster 1 includes a plurality of storage nodes 10 that are communicatively connected to each other. Each storage node 10 may be a computer or a server, but not limited thereto.

In an embodiment, each storage node 10 includes at least one processor 11, a plurality of storage devices 12, and a memory 13, wherein the at least one processor 11 is communicatively connected to each storage device 12 and the memory 13. Each storage device 12 may be an HDD, a solid state drive (SSD), or a non-volatile storage device of another kind, but not limited thereto.

In an embodiment, the memory 13 stores or includes at least a monitor module 14, a migration module 15, and a plurality of object storage modules 16. In an embodiment, each of the above-mentioned modules may be software, hardware, or firmware; in the case of hardware, it may be a processing unit, a processor, a computer, or a server with capabilities of data processing and computation; in the case of software or firmware, it may include instructions that can be executed by the processing unit, the processor, the computer, or the server. The modules may be installed in the same hardware device or distributed in different hardware devices.

In an embodiment, the storage cluster 1 provides a distributed storage system for storing data objects, such as files or data blocks. When a user stores a data object into the storage cluster 1, the user may specify whether or not to replicate the data object for storage.

If the user would like to replicate the data object, the user may specify the number of copies of the data object, and the storage cluster 1 selects a corresponding number of storage nodes 10, so that each selected storage node 10 stores one copy of the data object. The data objects are stored in the storage devices 12 of the selected storage nodes 10. When the user wants to read the data object, the storage cluster 1 selects one of the storage nodes 10 that stores the data object, and then instructs the selected storage node 10 to provide the data object. In this way, damage to a small number of storage nodes 10 does not cause the loss of the data object, which achieves safe and reliable data storage.

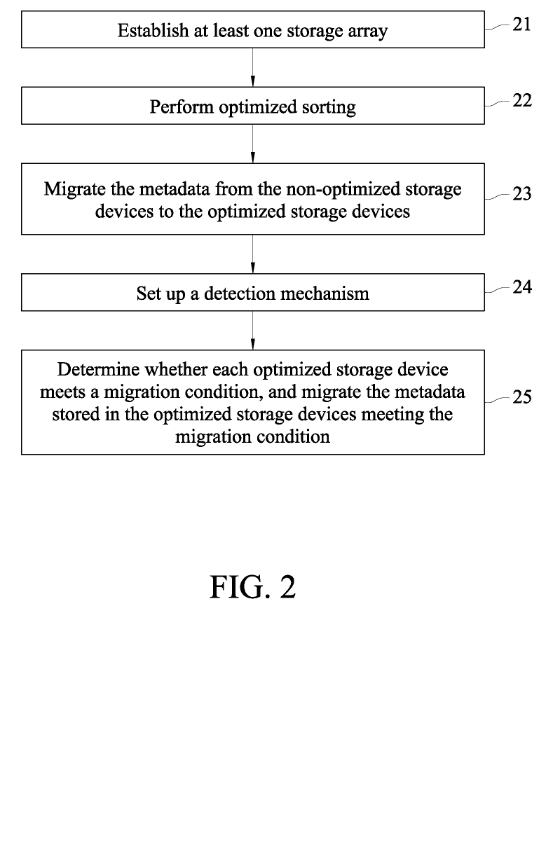

In an embodiment, the processor 11 of each storage node 10 may load and execute the monitor module 14, the migration module 15 and the object storage module 16 to execute the method for data access acceleration of a storage cluster shown in FIG. 2. In addition, the monitor module 14 is configured to monitor the status of the storage devices 12 and control the execution of the method for data access acceleration of a storage cluster, while the migration module 15 is configured to migrate the metadata stored in storage devices 12 through the object storage modules 16 (details later).

In an embodiment, the object storage modules 16 are configured for writing various kinds of data into the storage devices 12, and are also configured for reading various kinds of data from the storage devices 12, wherein the object storage modules 16 of each storage node 10 automatically synchronize with each other by replicating data objects for backups of the data objects or restoring previously stored data objects. In each storage node 10, the object storage modules 16 and the storage devices 12 are in a one-to-one configuration relation. In other words, each storage device 12 is associated with a corresponding object storage module 16. In addition, each object storage module 16 periodically returns the health status of its corresponding storage device 12 to the monitor module 14 of the same storage node 10.

FIG. 2 is a flowchart of a method for achieving data access acceleration of a storage cluster of an embodiment of the present disclosure.

As described above, the processor 11 of each storage node 10 can load and execute the monitor module 14, the migration module 15 and the object storage modules 16 to execute the method for data access acceleration of a storage cluster shown in FIG. 2, wherein the execution details of each storage node 10 for the process flow shown in FIG. 2 are the same as those of any other storage nodes 10. Therefore, the following discussions take one of the storage nodes 10 as an example and as the scope to illustrate the method for data access acceleration of a storage cluster shown in FIG. 2.

Firstly, the process shown in FIG. 2 may be started by an instruction of a user, or started automatically.

In an embodiment, in the storage node 10, the monitor module 14 monitors the status of each installed storage device 12. When, among the installed storage devices 12, the number of installed storage devices 12 that have not yet been used and that meet the condition set by the user (hereinafter referred to as reserved storage devices, which are usually SSDs) reaches a preset value, the monitor module 14 starts the execution of the process shown in FIG. 2.

At step 21, the monitor module 14 establishes at least one storage array with the aforementioned reserved storage devices, wherein each of the storage arrays consists of a plurality of storage units, and each storage unit is one of the aforementioned reserved storage devices.

For each storage array, the reserved storage devices constituting that storage array are regarded as a single storage device 12, and that single storage device 12 is that storage array. The data written into each storage array is replicated and stored in each storage unit of that storage array, so that the data stored in storage units of the same storage array are identical. For example, if the aforementioned storage arrays are redundant arrays of independent disks (RAIDs), then each storage array is a RAID 1 with data mirroring function.

In another embodiment, if the aforementioned storage arrays are RAIDs, then each storage array may be in the form of RAID 1, RAID 10, RAID 5, RAID 6, or RAID 7, etc., which can be used to complete the backup of the data contents stored in the single storage device 12 or restore the data contents stored in the single storage device 12.

In another embodiment, the monitor module 14 does not establish storage arrays, but maintains and uses the original storage devices 12. Therefore, step 21 may be omitted.

Next, at step 22, the monitor module 14 evaluates the storage devices 12 according to the input/output operations per second (IOPS) speed of each storage device 12 to perform an optimized sorting of the storage devices 12 according to their IOPS speeds.

In another embodiment, the monitor module 14 may perform a comprehensive evaluation based on the IOPS speed and the stability of each storage device 12 to perform the optimized sorting of the storage devices 12 according to the IOPS speed and the stability. For example, the stability of each storage device 12 may be the life expectancy of each storage device 12 or the temperature range of the environment of each storage device 12.

The IOPS speed is the speed at which a storage device 12 responds to read/write operations of an object storage module 16. The storage devices 12 have at least two different IOPS speeds. For example, each storage device 12 may be an HDD or an SSD, and the IOPS speed of an SSD is much higher than that of a traditional HDD.

In addition, the typical Self-Monitoring Analysis and Reporting Technology (S.M.A.R.T.) can monitor and record the performances of read-and-write heads, disks, motors, and circuits of an HDD through the detection commands inside the HDD, and compare them with the preset values, thus achieving self-monitoring, health status analysis and reporting and pre-warning of possible failures of HDDs.

The life expectancy of each storage device 12 is generated according to the historical record of the storage device 12 and/or a storage device of the same type as that of the storage device 12. The historical record may include the average life, the number and the time of abnormal power failures, the number and the time of system crashes, the length of time spent on performing read/write operations, alarm messages for abnormal conditions, and related system events of the storage device 12 and/or a storage device of the same type as that of the storage device 12. For example, the above-mentioned historical record may be inputted into a trained artificial intelligence model to instruct the artificial intelligence model to predict the life expectancy of the storage device 12, wherein the artificial intelligence model may be configured in each storage node 10, or in the storage cluster 1, or in an external server.

The monitor module 14 can set different weights for the above-mentioned IOPS speed and life expectancy to calculate a weighted average value of the IOPS speed and the life expectancy of each storage device 12, and then sort all the storage devices 12 according to the weighted average values. Next, a preset number of storage devices 12 with the highest weighted average values are classified as optimized storage devices 122, and the remaining storage devices 12 are classified as non-optimized storage devices 124.

For example, each storage device 12 may be an HDD, an SSD, or a storage array of SSDs. The IOPS speed of an SSD is much higher than that of a traditional HDD. The monitor module 14 calculates and obtains the life expectancies of the HDDs and the SSDs. Therefore, SSDs and storage arrays with longer life expectancies are classified as the optimized storage devices 122, and SSDs and storage arrays and all SSDs with a shorter life expectancy are classified as optimized storage device 122. Therefore, SSDs and storage arrays with longer life expectancy are classified as optimized storage device 122, while SSDs and storage arrays with shorter life expectancies and all HDDs are classified as the non-optimized storage devices 124.

Next, at step 23, the migration module 15 migrates, through the object storage modules 16, the metadata previously stored in the non-optimized storage devices 124 of the storage devices 12 to the optimized storage devices 122 of the storage devices 12.

The aforementioned migration refers to storing backup copies of the metadata stored in the non-optimized storage devices 124 into the optimized storage devices 122. After the migration, the metadata stored in the optimized storage devices 122 are used instead of the metadata stored in the non-optimized storage devices 124. In addition, the metadata stored in the non-optimized storage devices 124 may be deleted after the migration.

Each data object stored in the storage cluster 1 already includes data and metadata before it is stored in the storage cluster 1, wherein the data and the metadata are both parts of the data object. In the architecture of a typical file system, the metadata is located in the header of the data object and precedes the data. The data object is stored by the storage cluster 1 in the storage device(s) 12 of one or more storage nodes 10. The data and the metadata of each data object must be stored in the same storage device 12 and cannot be stored separately in different storage devices 12.

In the architecture of a typical conventional EXT4 file system, as described in a Wikipedia page on journaling file system (https://en.wikipedia.org/ wiki/Journaling_file_system), three levels of journals are respectively writeback, ordered and data, and the aforementioned three levels do not exist at the same time. The user may choose one of the three levels of journals, wherein only metadata is recorded in the journals for the writeback and the ordered levels. Although the above-mentioned journals of the two levels have disclosed that the metadata and data contents may be separately stored in different storage devices 12 by the user's input of program commands, compared with the present disclosure, the journals of the two levels, namely writeback and ordered, in the conventional technology are only a part of the data contents of the metadata. The journals of the two levels in the conventional technology need to recreate individual new journal data, which is different from the concept of the present disclosure that migrates the same metadata. In addition, the conventional technology cannot form a more efficient storage system after automatically migrating the metadata as the present disclosure does.

In the aforementioned migration, the metadata migrated by the migration module 15 is not the metadata in the data objects, but the metadata generated by the storage node 10 for the data objects. The metadata generated by the storage node 10 includes the specific storage locations of the corresponding data objects in the storage devices 12, as well as the attributes of the data objects. Therefore, the above-mentioned metadata migrated by the migration module 15 are not the metadata in the data objects and are not parts of the data objects, so the metadata may be stored separately in storage devices 12 that are different from those storing the corresponding data objects.

Moreover, the following metadata refers to the above-mentioned metadata migrated by the migration module 15.

A storage device 12 typically stores a plurality of data objects, and before the above-mentioned migration, each data object and its metadata are stored in the same storage device 12. When a data object is replicated and stored in multiple storage devices 12 of multiple storage nodes 10, the data object has exactly the same data contents in every storage node 10. However, the data object is respectively stored in different locations in the storage devices 12 of the storage nodes 10. Therefore, the metadata of the data object is different in each storage node 10.

Before an object storage module 16 reads and writes a data object, the object storage module 16 must first read the metadata of the data object to know the specific storage location of the data object in the storage device 12 for performing read/write operations. Therefore, the above-mentioned migration is migrating the metadata from the non-optimized storage devices 124 to the optimized storage devices 122, which can improve access speed and/or storage security of the metadata, which in turn can improve access speed and/or access security of the object storage modules 16 for data objects.

For example, the locations of metadata and data objects in the storage devices 12 are usually not contiguous/continuous. Therefore, when reading a data object in a storage device 12, if the storage device 12 is a traditional HDD, its read-and-write head needs to move to the location of the metadata to find out the location of the data object, and then move to the location of the data object to finish the read operation. The time required to change the location of the read-and-write head greatly reduces the data reading speed. Therefore, migrating the metadata to the optimized storage devices 122 with faster access speed, such as SSDs, can significantly increase the read/write speed.

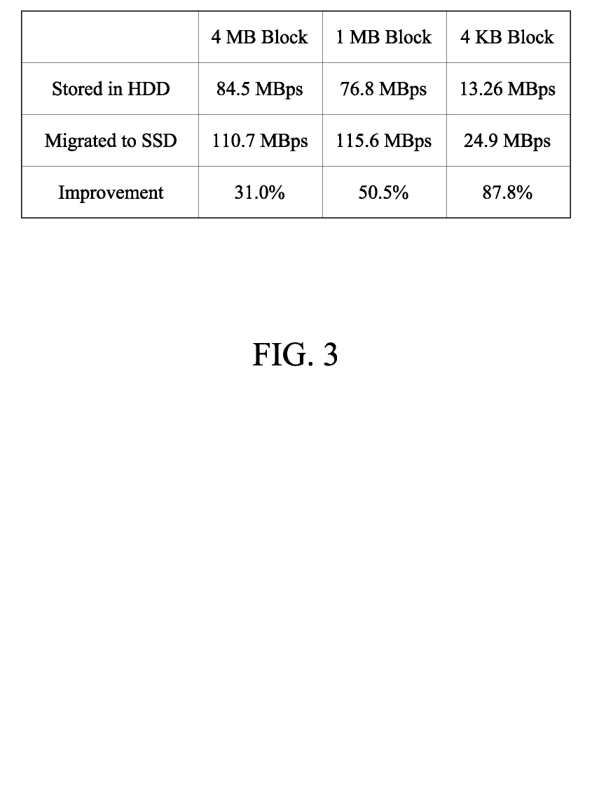

The test results of read/write speeds of data objects in an embodiment shown in FIG. 3 include the read/write speeds when the data objects and the metadata are stored in the same HDD, the read/write speeds after the metadata are migrated to an SSD, and the percentage of speed improvement between the two kinds of drives, for three different data block sizes. As can be seen in FIG. 3, migrating the metadata to the SSD increases the read/write speeds by 31% to 87.8%, which is a significant improvement.

If a storage device 12 is a storage array formed by a plurality of storage units, the metadata migrated to that storage device 12 would be replicated and stored in each storage unit of that storage array 12 so that each of those storage units stores a copy of exactly the same metadata. In this scenario, even if the metadata in one of the storage units is corrupted, the same metadata is still stored in the other storage units to achieve data security.

When the metadata stored in a plurality of non-optimized storage devices 124 of each of a plurality of storage nodes 10 need to be migrated, the metadata migration may be performed one by one for each of those storage nodes 10. In other words, only one storage node 10 performs step 23 at a time. For example, the minimum value or the average value of the life expectancies of the non-optimized storage devices 124 of each storage node 10 that need to migrate the metadata may be used as the life expectancy of the storage node 10, and then all the storage nodes 10 may be sorted according to their life expectancies. Step 23 is then performed sequentially by the storage nodes 10 starting with the storage node 10 with the shortest life expectancy.

In each storage node 10, its migration module 15 may migrate the metadata in each non-optimized storage device 124 one by one. In other words, only the metadata in one non-optimized storage device 124 is migrated to one optimized storage device 122 at a time. For example, all non-optimized storage devices 124 that need to migrate out the metadata may be sorted by their life expectancies, and then the metadata are migrated in an order starting with the non-optimized storage device 124 with the shortest life expectancy. After the metadata of non-optimized storage devices 124 in a storage node 10 have been migrated, the metadata of the non-optimized storage devices 124 in the next storage node 10 are migrated.

In the same storage node 10, the migration module 15 may migrate the metadata in each non-optimized storage device 124 to a different optimized storage device 122, or migrate the metadata in multiple non-optimized storage devices 124 to the same optimized storage device 122.

The above-mentioned one-by-one migration mechanism can minimize the impact of metadata migration on the performance of storage cluster 1 and ensure data security and fast access.

Alternatively, if it is acceptable to have a greater performance impact in exchange for a shorter overall migration time, the migration module 15 may migrate the metadata in each non-optimized storage device 124 in a storage node 10 at the same time when the migration module 15 is migrating the metadata in that storage node 10. Further, the metadata in each non-optimized storage device 124 in each storage node 10 may be migrated simultaneously. This simultaneous migration is applicable when the storage cluster 1 is offline and not in service, or during the pre-service initialization of the storage cluster 1, without compromising data security.

At step 24, the monitor module 14 sets up a detection mechanism required periodically or in response to an unexpected event according to the optimized sorting.

The monitor module 14 may set threshold values corresponding to the above-mentioned IOPS speed and stability, and periodically monitor whether the IOPS speed or the stability of each optimized storage device 122 has dropped to the corresponding threshold value, so as to establish the detection mechanism.

Next, at step 25, the migration module 15 of each storage node 10 determines whether each optimized storage device 122 that stores metadata in the same storage node 10 meets a migration condition, which is the detection mechanism set up at step 24. If an optimized storage device 122 meets the migration condition, the migration module 15 migrates the metadata stored in that optimized storage device 122 to another storage device 12 in the same storage node 10.

The execution timing of step 25 is controlled by the monitor module 14. In an embodiment, the monitor module 14 may actively detect whether a status event occurs in the storage devices 12 in the same storage node 10 according to a fixed period. If there is a status event, the monitor module 14 instructs the migration module 15 to perform step 25, wherein the status event is that a newly installed storage device joins the storage devices 12, or one of the storage devices 12 is removed or malfunctions. In addition, the status event may occur when the storage node 10 is in a service-on state or a service-off state.

Alternatively, in some servers, if a storage device such as an HDD has just been installed, been removed, or malfunctioned, the server generates a corresponding status event (e.g., a Udev/HAL event in a Linux operating system) and notifies relevant processes. If such a server is used as a storage node 10, the monitor module 14 of that storage node 10 may passively receive the aforementioned status event and, upon receiving the status event, instructs the migration module 15 to execute step 25.

As mentioned above, at step 25, the migration module 15 determines whether each optimized storage device 122 that stores the metadata meets the migration condition.

In an embodiment, the migration condition is that the IOPS speed of an optimized storage device 122 has dropped to a preset threshold value. Alternatively, if the optimized storage device 122 is a storage array including a plurality of storage units, the corresponding migration condition is that the IOPS speed of at least one of the storage units of the optimized storage device 122 has dropped to the threshold value. In this way, the metadata stored in a storage device 12 can be migrated before the storage device 12 malfunctions to ensure data security.

In another embodiment, the migration condition is that the life expectancy (stability) of an optimized storage device 122 has dropped to a preset threshold value. Alternatively, if the optimized storage device 122 is a storage array including a plurality of storage units, the corresponding migration condition is that the life expectancy of at least one of the storage units of the optimized storage device 122 has dropped to the threshold value. In this way, the metadata stored in an optimized storage device 122 can be migrated before the optimized storage device 122 malfunctions to ensure data security.

In still another embodiment, the migration condition is that at least one of the storage units of an optimized storage device 122 has been removed or has malfunctioned. This migration condition is applicable only to a storage device 12 consisting of a plurality of storage units. If the storage units in a storage array are SSDs, the SSDs have a higher malfunction rate and successive malfunctions may occur in a plurality of storage units. Therefore, when a storage unit is removed or malfunctions, thus reducing the number of available storage units in the storage array, the metadata stored in the other storage units in the same storage array may be proactively migrated to ensure data security.

As described above, at step 25, the migration module 15 migrates the metadata stored in an optimized storage device 122 that meets the migration condition to another storage device 12. In an embodiment, the another storage device 12 is the non-optimized storage device 124 that originally stores the metadata. In other words, the migration module 15 migrates the metadata back to the non-optimized storage device 124 where the metadata was originally stored.

Alternatively, in another embodiment, the another storage device 12 is a storage device 12 that is different from the aforementioned optimized storage device 122 and the aforementioned non-optimized storage device 124. For example, the another storage device 12 may be another storage device 12 that has a life expectancy longer than that of the optimized storage device 122 that meets the migration condition, or another storage device 12 that has a storage space allocated to the metadata, wherein the storage space is larger than that of the optimized storage device 122 that meets the migration condition.

At step 25, when each of a plurality of storage nodes 10 has a plurality of optimized storage devices 122 that meet the migration condition and need to migrate the metadata therein, the metadata of each storage node 10 may be migrated one by one. In other words, only one storage node 10 performs step 25 at a time. For example, the minimum value or the average value of the life expectancies of all optimized storage devices 122 that need to migrate out the metadata of each storage node 10 can be used as the life expectancy of that storage node 10, and all the storage nodes 10 are sorted according to their life expectancies. Step 25 is then performed sequentially by the storage nodes 10 starting with the storage node 10 with the shortest life expectancy.

In each of the storage nodes 10, its migration module 15 may determine one by one whether each of the optimized storage devices 122 that stores the metadata meets the migration condition, and if one meets the migration condition, then the migration module 15 migrates the metadata stored in the one optimized storage device 122. In other words, only the metadata in one optimized storage device 122 is migrated at a time. For example, all the optimized storage devices 122 that need to migrate metadata may be sorted according to life expectancy. Then, the metadata is migrated in an order starting from the optimized storage device 122 with the shortest life expectancy. After the metadata in the optimized storage devices 122 that meet the migration condition in one storage node 10 have been migrated, the metadata in the optimized storage devices 122 that meet the migration condition in the next storage node 10 are migrated.

In the same storage node 10, the migration module 15 may migrate the metadata in each optimized storage device 122 to a different storage device 12, or migrate the metadata in multiple optimized storage devices 122 to the same storage device 12.

The above-mentioned one-by-one migration mechanism minimizes the impact of metadata migration on the performance of the storage cluster 1 and ensures data security and fast access.

Alternatively, in an embodiment, if it is acceptable to have a greater performance impact in exchange for a shorter overall migration time, the migration module 15 may migrate the metadata in each optimized storage device 122 that meets the migration condition in a storage node 10 at the same time when the migration module 15 is migrating the metadata in that storage node 10. Further, the metadata in each optimized storage device 122 that meets the migration condition in each storage node 10 may be migrated simultaneously. This simultaneous migration is applicable when the storage cluster 1 is offline and not in service, or during the pre-service initialization of the storage cluster 1, without compromising data security.

The present disclosure also provides a computer-readable storage medium, such as memory, magnetic tape, magnetic disk, or optical disk. The computer-readable storage medium may be configured to store instructions that may be read by a storage node or a storage cluster described above to perform the method for achieving data access acceleration of a storage cluster described above. In an embodiment, the computer-readable storage medium is a non-transitory computer-readable storage medium.

In summary, the technical solution of the present disclosure focuses on migrating the metadata of data objects from non-optimized storage devices to optimized storage devices with higher IOPS speeds and/or longer life expectancies, and, after the aforementioned migration, determining whether the metadata needs to be moved out of the optimized storage devices according to the statuses of the optimized storage devices, so as to improve the read/write performance and the storage security of the data objects.

While some of the embodiments of the present disclosure have been described in detail above, it is, however, possible for those of ordinary skill in the art to make various modifications and changes to the particular embodiments shown without substantially departing from the teaching and advantages of the present disclosure. Such modifications and changes are encompassed in the spirit and scope of the present disclosure as set forth in the appended claims.

What is claimed is:

1. A method for achieving data access acceleration of a storage cluster, performed by a storage node in the storage cluster, wherein the storage node comprises a plurality of storage devices having at least two different input/output operations per second (IOPS) speeds, the method comprising:
evaluating the IOPS speed of each of the plurality of storage devices to perform an optimized sorting of the plurality of storage devices;
migrating metadata originally stored in a non-optimized storage device in the optimized sorting of the plurality of storage devices to an optimized storage device in the optimized sorting of the plurality of storage devices;
setting up a detection mechanism required periodically or in response to an unexpected event according to the optimized sorting; and
in the detection mechanism, if the IOPS speed of the optimized storage device has dropped to a threshold value, migrating the metadata stored in the optimized storage device back to the non-optimized storage device or to another storage device of the plurality of storage devices according to a system resource of the storage node.

2. The method according to claim 1, further comprising:
conducting a comprehensive evaluation based on the IOPS speed and stability of each of the plurality of storage devices to perform the optimized sorting of the plurality of storage devices, wherein the IOPS speed and/or the stability of the optimized storage device is higher than the IOPS speed and/or the stability of the non-optimized storage device.

3. The method according to claim 2, wherein the stability of each of the plurality of storage devices is generated according to a historical record of each of the plurality of storage devices and/or a historical record of a different storage device of a same type as that of each of the plurality of storage devices.

4. The method according to claim 2, wherein the stability of each of the plurality of storage devices is a life expectancy of each of the plurality of storage devices or a temperature range of an environment of each of the plurality of storage devices.

5. The method according to claim 2, further comprising:
in the detection mechanism, if the IOPS speed or the stability of the optimized storage device has dropped to a corresponding threshold value, migrating the metadata stored in the optimized storage device back to the non-optimized storage device or to the another storage device according to the system resource.

6. The method according to claim 5, wherein the stability of the another storage device is higher than the stability of the optimized storage device, and wherein the system resource is a storage space in the another storage device allocated to the metadata.

7. The method according to claim 5, wherein the storage space in the another storage device allocated to the metadata is larger than a storage space in the optimized storage device allocated to the metadata, and wherein the system resource is the storage space in the optimized storage device allocated to the metadata.

8. The method according to claim 1, wherein the unexpected event comprises a newly installed storage device joining the plurality of storage devices, or one of the plurality of storage devices being removed, or malfunction of one of the plurality of storage devices.

9. The method according to claim 1, wherein the optimized storage device is a storage array comprising a plurality of storage units, and wherein each of the plurality of storage units stores a copy of the metadata.

10. The method according to claim 9, further comprising:
in the detection mechanism, if at least one of the plurality of storage units of the optimized storage device has been removed or has malfunctioned, migrating the metadata stored in the optimized storage device back to the non-optimized storage device or to the another storage device according to the system resource.

11. The method according to claim 1, wherein the storage cluster comprises a plurality of the storage nodes, wherein each of the plurality of storage nodes performs the method, wherein the plurality of storage nodes migrate the metadata in the plurality of storage nodes according to a migration order of the plurality of storage nodes, and wherein the plurality of storage nodes migrate the metadata in only one of the plurality of storage nodes at a time.

12. The method according to claim 11, further comprising:
determining the migration order according to the stability of the optimized storage device of each of the plurality of storage nodes; and
in each of the plurality of storage nodes, migrating the metadata stored in the optimized storage device of the storage node back to the non-optimized storage device of the storage node or to the another storage device of the storage node, according to the migration order of the plurality of storage nodes.

13. A storage node, comprising:
a plurality of storage devices having at least two different input/output operations per second (IOPS) speeds; and
at least one processor configured for:
evaluating the IOPS speed of each of the plurality of storage devices to perform an optimized sorting of the plurality of storage devices;
migrating metadata originally stored in a non-optimized storage device in the optimized sorting to an optimized storage device in the optimized sorting;
setting up a detection mechanism required periodically or in response to an unexpected event according to the optimized sorting; and
in the detection mechanism, if the IOPS speed of the optimized storage device has dropped to a threshold value, migrating the metadata stored in the optimized storage device back to the non-optimized storage device or to another storage device of the plurality of storage devices according to a system resource of the storage node.

14. A storage cluster, comprising a plurality of storage nodes, wherein each of the plurality of storage nodes comprises at least one processor and a plurality of storage devices having at least two different input/output operations per second (IOPS) speeds, and wherein in each of the plurality of storage nodes, the at least one processor is configured for:
evaluating the IOPS speed of each of the plurality of storage devices to perform an optimized sorting of the plurality of storage devices;
migrating metadata originally stored in a non-optimized storage device in the optimized sorting to an optimized storage device in the optimized sorting;
setting up a detection mechanism required periodically or in response to an unexpected event according to the optimized sorting; and
in the detection mechanism, if the IOPS speed of the optimized storage device has dropped to a threshold value, migrating the metadata stored in the optimized storage device back to the non-optimized storage device or to another storage device of the plurality of storage devices according to a system resource of the storage node.
